(19) United States
(12) Patent Application Publication
(10) Pub. No.: US 2014/0055252 A1
(43) Pub. Date: Feb. 27, 2014

(54) VEHICLE WITH SAFETY PROJECTOR

(71) Applicant: Jay Ascencio, White Lake, MI (US)

(72) Inventor: Jay Ascencio, White Lake, MI (US)

(73) Assignee: FORD MOTOR COMPANY, Dearborn, MI (US)

(21) Appl. No.: 13/593,541

(22) Filed: Aug. 24, 2012

(51) Int. Cl. B60Q 1/00

(52) U.S. Cl. 340/425.5

(57) ABSTRACT

A vehicular alerting system includes at least one light source mounted on a vehicle. The light source is configured to emit a light beam, forming a projection. More particularly, the projection is projected peripherally substantially all around the vehicle onto a vehicular travelling surface, up to a predetermined distance from the vehicle, establishing a vehicular unsafe zone.

### BACKGROUND

This invention relates generally to safety systems applied within Powered Material Handling Vehicles (PMHVs) while operating over production shop floors, and, more particularly, towards systems that indicate a proximity of the PMHV to shop floor pedestrians.

As part of conventional manufacturing processes, shop floor operations include transfer of materials, such as raw materials, operational hardware, pallets, and half-finished products, from one part of a floor to another. Generally, a majority of such transfer is performed through in-house material transferring vehicles, referred to as the PMHVs, such as forklifts. With shop floors usually including workers, supervisors, and other personnel, dedicated lanes are marked for the PMHV's travel, with the aim of establishing safe movement areas of such in-house vehicles throughout the shop floor. Such lanes, in particular, are intended to keep shop floor personnel a safe distance from the path reserved for the PMHV movements. Additionally, PMHVs, while travelling over shop floors, generally include alarm functions, emergency brakes, speed governors, warning stickers, audio warnings, etc., that aim to help prevent mishaps, avoiding potential injuries to shop floor personnel, while also preventing inconveniences in attaining productions targets.

Inspite of having the above noted measures in place, several accidents involving PMHVs have been reported over the years. On many occasions, shop floor personnel unknowingly venture into the PMHV's travel path, and alarm functions, stickers, etc., disposed on such vehicles fail to prevent the shop floor personnel coming dangerously close to an oncoming PMHV. In particular, these efforts fail to prevent shop floor personnel from entering into an unsafe zone, identified generally as a region within a distance of 2 feet around an operational PMHV.

Room for improvements therefore exists to help alert shop floor personnel that they are entering into an unsafe zone, to thereby help prevent them from coming dangerously close to PHMVs.

### SUMMARY

One embodiment of the present disclosure describes a vehicular alerting system that includes at least one light source mounted on a vehicle, where the light source is configured to emit a light beam, forming a projection. More particularly, the projection is projected peripherally substantially all around the vehicle onto a vehicular travelling surface, up to a predetermined distance from the vehicle, establishing a vehicular unsafe zone.

Another embodiment of the present disclosure describes a vehicle proximity warning system including at least one laser mounted on a vehicle. The laser is configured to emit a laser beam, forming a projection, projected peripherally substantially all around the vehicle onto a vehicular travelling surface. Particularly, the projection is projected up to a predetermined distance from the vehicle, establishing a vehicular unsafe zone. Moreover, the projection includes at least one of an image, a visually perceivable message, and a demarcation curve. The system further includes at least one of an optical member, including an interchangeable lens, configured to be positioned in front of the laser, enabling the laser beam to pass across the optical member, forming the projection.

Certain embodiments of the present disclosure describe a method of safely operating a vehicle. The method includes projecting a laser beam via at least one laser, forming a projection, where the laser is mounted on the vehicle and the projection is projected peripherally substantially all around the vehicle onto a vehicular travelling surface. More particularly, the projection is projected up to a predetermined distance from the vehicle, establishing a vehicular unsafe zone.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary projection concept according to the present disclosure.

FIG. 2 depicts an exemplary vehicular alerting system based on the projection concept of FIG. 1.

FIG. 3 illustrates an exemplary application of the vehicular alerting system when installed in a PMHV.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes systems and methods for providing a visual safety demarcation of an unsafe zone around Powered Material Handling Vehicles (PMHVs), operating over shop floors. To this end, a laser based light source, disposed on the PHMV, allows an unsafe zone around the PHMV to be visually projected and demarcated up to a predefined distance from the vehicle through a laser based projection system. This happens upon the beginning of an operation of the PHMV. In particular, the system includes demarcation of the unsafe zone through images, curves, or messages easily perceivable by shop floor personnel.

### Exemplary Embodiments

Powered material handling vehicles, commonly known as PMHVs, are employed in sectors of manufacturing, fabrication, metalworking, etc., to transport unfinished goods, raw materials, and the like, within manufacturing plants. Industrial mandates require all operational PMHVs to comply with a 2-foot rule, which prescribes restrictions to the presence of pedestrians, personnel, etc., around the periphery of a PMHV up to a distance of 2 feet, during PMHV operations and movements. Accordingly, this 2 feet distance around the PMHV periphery is generally categorized as a vehicular unsafe zone. More particularly, when the keys of the PMHV are in an ‘on’ position, the PMHV is classified to be in an operational state. Over the years, several injuries have been observed and reported when a violation of the 2-foot rule occurs.

Such unintentional violations are commonly observed to be caused by the pedestrians' negligence, who, on several occasions, are unaware of an approaching PMHV. More specifically, improper demarcations and a lack of clarity of the unsafe zone, prevalent around the periphery of an operational PMHV, may cause pedestrians to inadvertently venture dangerously close to such vehicles.

Equipping pedestrians with the ability to clearly distinguish the unsafe zone around a PMHV, over a PMHV's travel path, can therefore offer safer working environments in industries that include regular in-plant PMHV movements.

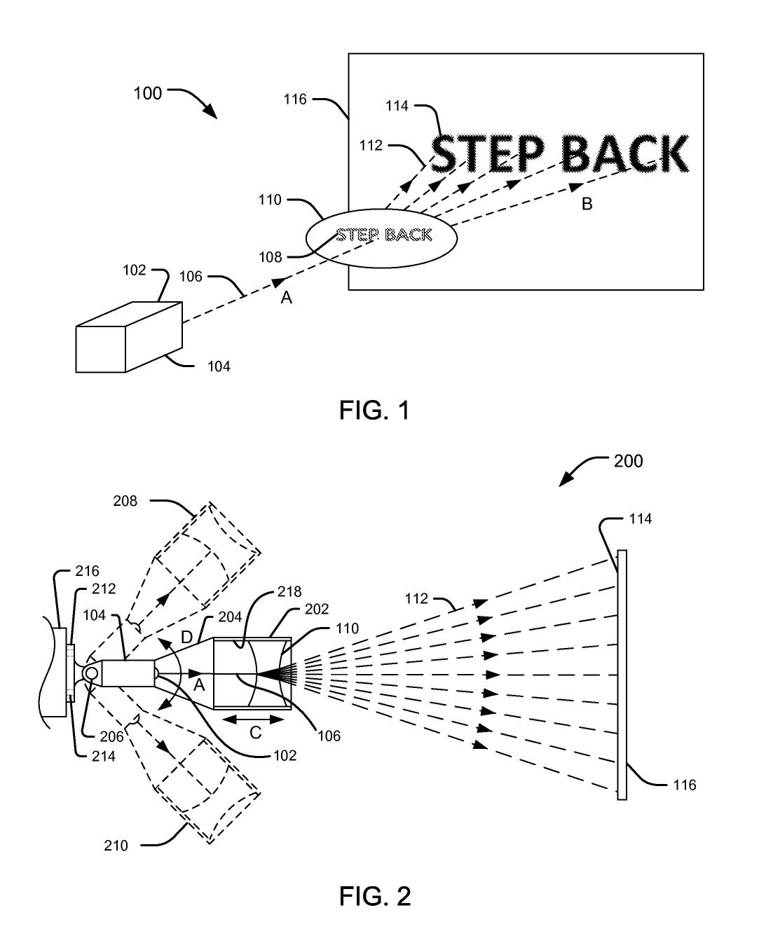

Accordingly, FIG. 1 depicts an exemplary projection scheme 100 as part of the present disclosure. The projection scheme 100 includes a light source 102 enclosed within a housing 104, having a member, which can optionally be an optical member 110, positioned in-line and in front of the light source 102 in such a manner that a light beam 106 emitted from the light source 102 is enabled to pass across the optical member 110. The direction of the light beam's travel is depicted by arrow A. Travelling beyond the optical member 110, the light beam 106 is configured to become refracted rays 112, the direction of which is depicted by arrow B, reaching and being projected onto a surface 116. It is understood that the light beam 106 may represent a plurality of light beams, when more than one light source 102 is employed. For ease in understanding however, only a single light beam 106 is depicted. The optical member 110 includes an impression 108 of at least one of an image, a visually perceivable message, and a demarcation curve, enabling the refracted rays 112 to carry the impression forward and project the impression 108, forming a projection 114, onto the surface 116. For example, in the figure, the projection 114 is configured to be a visually perceivable message ‘STEP BACK’, which visibly urges shop floor personnel to step back from his/her current position, out of the unsafe zone. Further, the surface 116, over which the projection 114 is projected, is understood to be a vehicular travelling surface or a ground surface designated for in-plant vehicular movements.

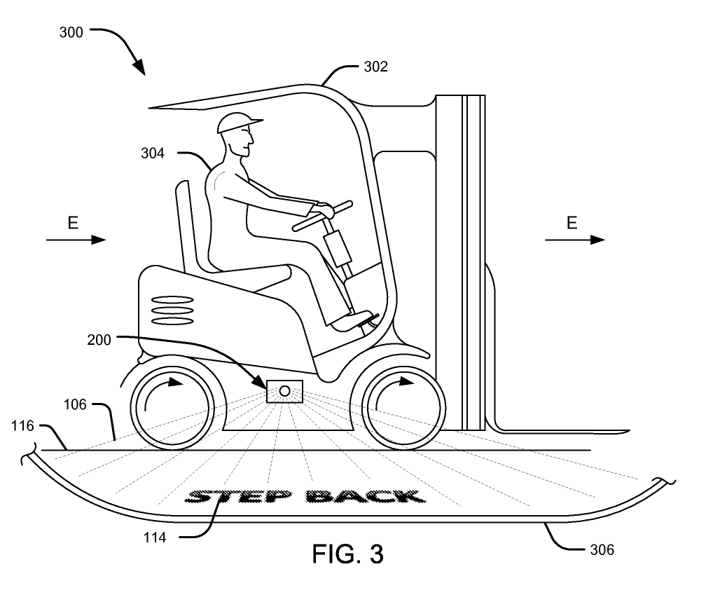

Based on the projection scheme 100, FIG. 2 depicts an assembly 200, which comprises the components described for the projection scheme 100. In detail, the components include the housing 104, the light source 102, the optical member 110, a connector casing 204, and an enclosure 202. The housing 104 is cylindrical along its longitudinal axis, forming a substantially rigid structure, which is resistant to deformations applicable during a field operation. The housing 104, within which the light source 102 is suitably enclosed, adheres to the outer confines of the light source 102, while encapsulating the light source 102 within itself. Securing the light source 102 within the housing 104 may be enabled through clippings or snap features disposed within the housing 104, allowing for an easy installation and removal. More particularly, the housing 104 includes a mechanism to allow it to be suitably mounted to a vehicle portion 216 via a flange section 212, with the vehicle portion 216 forming one part of a PMHV 302 (shown in FIG. 3). Having the optical member 110 assembled along with the housing 104, such a mounting enables the assembly 200 of the light source 102 and the optical member 110 to project a projection around substantially all of a peripheral portion of the PMHV 302, up to a predetermined distance from the PMHV 302, during a vehicular operation. In particular, the flange section 212 includes openings 214 to enable bolted fastenings, reliably mounting the housing 104 to the vehicle portion 216.

The housing 104 includes provisions to have more than one light source 102 encapsulated into itself, forming a single light source unit for housing and providing the projection 114 through multiple light beams. In addition, the housing 104 can enable the light source 102 to be replaced by different light sources having different color characteristics, wavelength, intensity, etc., enabling the possibility of a broad range of variations in projections, eventually aiming to enhance visual appeal to a viewer. Further, certain embodiments can include provision to have both the light source 102 and the optical member 110 enclosed in the housing 104. Such an embodiment may enable for a compact, portable, and a versatile projection unit. Furthermore, manufacturing the housing 104 may include traditional practices, well known in the art, and materials like high-grade plastic, stainless steel, etc., can be used.

The projection scheme 100 is configured to be positioned on the PMHV 302 in such a position so as to allow for the projection on the floor to extend substantially all around the vehicle, thus clearly indicating the safety zone around the vehicle. More particularly, in the preferred embodiment, the projection scheme 100 is positioned under the PMHV 302 in a position where the light from the vehicle can reach all around the vehicle.

Likewise, the optical member 110 is similarly configured to be housed within an enclosure 202. Similar to the construction of the housing 104, the enclosure 202 is substantially cylindrical in shape, having measures to house the optical member 110 within the confines of its inner wall 218. Such measures may include snapping and clipping mechanisms, well known in the art, to position and retain the optical member 110. Further, the inner wall 218 may include tracks or rails over which the optical member 110 can travel back and forth in the direction of the arrow C shown in FIG. 2. It is understood that such travel or movability, in relation to the light source 102, is configured to vary the size of the projection 114. Particularly, such movability enabled through the tracks or rails allows focusing the projection 114 on the surface 116 as well.

An assemblage of the light source 102 and the optical member 110, housed within the housing 104 and enclosure 202, respectively, is enabled through a connector casing 204, fastening the housing 104 and the enclosure 202 to each other via threaded connections. Such threaded connections also aim to provide easy assembly and disassembly of the entire unit or assembly 200, providing for a convenient replacement, addition, and removal, of the light source 102. Moreover, the threaded connections also aim to provide for replacing the optical member 110 with different optical members, and can be helpful in enabling addition of more optical and/or impression members which are specific to the projection 114, as desired.

Typically, incandescent light sources generate a broad spectrum of light, delivering light in all directions at the same time. Light from such light sources thus appear to be white, scattering over their travel path while lacking coherence. The light beam 106, emitting from the light source 102, in preferred embodiments, can thus be a monochromatic beam of light, such as laser, and accordingly, the light beam 106 can be a laser beam, configured to deliver a specific wavelength of visible light. This wavelength establishes a laser's color, as seen by the eye, emitting light in a single, narrow beam, lighting only a small limited area. Moreover, the usage of laser over incandescent light sources limits a considerable percentage of the energy utilized by standard light sources as well, which is wasted as heat on many occasions. More particularly, lasers are much more efficient, as the energy used to create the light is focused in the beam. Furthermore, the laser adopted in the assembly 200 is modulated for indoor human viewing and application, particularly having no or negligible effects to those who may view the light.

The optical member 110 includes interchangeable lenses, and can accordingly be at least one of a concave lens, convex lens, cylindrical lens, or an impression or projection specific optical member, depending upon the usability and application. Particularly, optical members, such as the optical member 110, which are specific to laser projections, enabling one to attain images, messages, curves, etc., projected onto a surface, such as the surface 116, are well known to the skilled in the art and thus will not be discussed.

In addition, the optical member 110 may include a Fresnel lens composed of a number of small lenses arranged to make a lightweight lens of large diameter and short focal length suitable to be employed for laser projections according to the embodiments of the present disclosure. In addition, other laser diffraction techniques can be used. Some techniques result in diffracting the oncoming laser beam to form a projection of an arrayed pattern or a broken line over the surface 116.

In further embodiments, the assembly 200 formed by the housing 104 and the enclosure 202, enclosing the light source 102 and optical member 110, respectively, can be configured to move angularly in relation to the PMHV 302 to vary a predetermined distance and position of the projection 114 in relation to the vehicle. Accordingly, movement 208 is depicted towards one direction, while movement 210 is depicted in an opposite angular direction. Here, it is understood that the predetermined distance forms a part of the 2-foot rule in establishing the unsafe zone around the PMHV 302. Such angular movements can be enabled through a hinged connection 206 disposed between the assembly 200 and the PMHV 302, allowing the assembly 200 to swing in a direction depicted through the arrow D. Such angular movement enables the unsafe zone to extend to a greater or a lesser distance in relation to a practiced mandate. Particularly, such a feature enables variations in distances, and accordingly the coverage of unsafe zone around the PMHV 302, and can thus be applied according to the type of PMHV employed.

As part of embodiments of the assembly 200 depicted in FIG. 2, it is understood that there may be more than one laser source or LED encapsulated into a single laser module, enclosed within the housing 104, allowing multiple light beams or laser beams, such as the light beam 106, to be emitted and diverge out of the assembly 200. Such emission and consequent divergence of the beams enable the projection 114 to be distributed onto the surface 116 adequately and appropriately, the surface 116 being a ground surface as depicted in FIG. 3. More particularly, the encapsulation of multiple laser sources or LEDs may enable the projection 114 to include multiple combinations of straight lines, curves, messages, images, arrays of images, etc., running all around the PMHV 302, establishing the unsafe zone.

FIG. 3 depicts the PMHV 302, driven by a driver 304, during an exemplary operation travelling over the surface 116, in a direction depicted through the arrow E, along with the assembly 200 in application within the PMHV 302. The assembly 200 projects the projection 114 peripherally around the vehicle, as shown in the figure. During an application, the projection 114 may include a combination of a straight line or a curve 306, along with the message ‘STEP BACK’, as shown, which may be enabled through the encapsulation of more than one laser source into a single laser module, as noted above, categorically defining the unsafe zone. While the figure depicts the employment of the assembly 200 on one side of the PMHV 302, for a partial peripheral coverage of the projection 114, it will be understood that the assembly 200 is required to be mounted to the sides, front, and back, of the PMHV 302 as well. Accordingly, for the PMHV 302, a total projection system is thus enabled only when at least all the four sides of the PMHV 302 employ the assembly 200. A vehicular alerting system in a vehicle, such as the PMHV 302, referred to as a vehicle proximity warning system 300, is thus established. To enable all-around projection, it is understood that at least four of the assemblies 200 need to be incorporated into the PMHV 302, to cover all four sides of the vehicle. This enables a visible disposal of the projection 114 all around the PMHV 302, as desired, causing workers, shop floor personnel, etc., to alert themselves of their position in relation to the unsafe zone from all side of the vehicle. Particularly, if a pedestrian steps into the unsafe zone, the laser projection 114 will shine onto a part of their body that is in the zone, conveying their position visually and accurately in relation to the PMHV 302, while also alerting and warning the pedestrian to step out of the unsafe zone in order to avoid any possible mishaps.

Alternatively, configurations of such a placement of the assembly 200 may be varied, and a unitary unit comprising a plurality of the assembly 200 (at least one in all four major directions) can be placed and projected from the top of the PMHV 302. Other configurations may include the system 300 to include variations in the number of the assembly 200 to be employed in the vehicle, and such may be known to the skilled in the art, and may be possible through appropriate placement of the assembly 200 around the PMHV 302. The configurations of the assembly 200 within the system 300 are thus not limited in any way.

In some embodiments, the system 300 may include only one of the assembly 200 rather than having them as multiple units integrated into the system 300. In such an embodiment, the assembly 200 may be configured to rotate rapidly around an axis, projecting the projection 114 around the vehicle, appearing to produce a continuous border or a curve around the PMHV 302, establishing the unsafe zone. More particularly, this would equip a shop floor personnel to experience an appealing or a catchy visualization of a curve, message, etc., as the singular rotating assembly 200, forming the system 300, may appear as flashes of lighting around the PMHV 302, thereby garnering or calling for the personnel's attention to an approaching vehicle.

During an operation of the assembly 200, the at least one light source 102 employed in the assembly 200, emits the light beam 106. The light beam 106 being a laser beam, reaches the optical member 110. Subsequently, the optical member 110, receiving the light beam 106, refracts the beam 106, causing the beam to form refracted rays 112, while enabling the beam 106 to travel either in its original direction, or deflect, all based according to the beam's angle of incidence on the optical member 110. The optical member 110 having an impression of at least an image, message, curve, etc., causes the refracted rays 112 to carry the impression towards the projection surface 116, thereby forming the projection 114. The refracted rays 112, thus formed by the light beam 106 passing across the impression 108, causes the impression 108 to be projected over the surface 116, allowing the impression specific projection 114 to be visually viewed by a viewer. With the projection 114 forming the unsafe zone, the system 300 accordingly provides for a method for safely operating the PMHV 302 on shop floors.

In other embodiments, all operating PMHVs may be configured to be connected to a wireless central network through which a user can remotely configure and control different aspects of the system 300. Exemplarily, the type and number of the light source 102 and the optical member 110 applied in all the PMHVs may be varied and set according to a desired configuration. This may consequently allow all PMHVs operating within a plant to operate according to a similar theme or mandate.

Optionally, the system 300 may be disassembled, stored, and retrieved, as a kit, enabling its easy installation and removal from the PMHV 302. This may depend upon an operational state of the PMHV 302. As noted, when the PMHV 302 lies in a non-operational state, the system 300 can be configured to be removed from the vehicle and applied to other operational PMHVs, thereby extending cost and operational benefits to a user.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

What is claimed is:

1. A vehicular alerting system comprising:
at least one light source mounted on a vehicle, the light source configured to emit a light beam, forming a projection, wherein the projection is projected peripherally substantially all around the vehicle onto a vehicular travelling surface, up to a predetermined distance from the vehicle, establishing a vehicular unsafe zone.

2. The system of claim 1, wherein the projection comprises at least one of the following:
an image;
a visually perceivable message; and
a demarcation curve.

3. The system of claim 1, wherein the light source is a laser, and the light beam is a laser beam.

4. The system of claim 1 further comprising at least one member, positioned in front of the light source, enabling the light beam to pass across the member, forming the projection.

5. The system of claim 4, wherein the member is an optical member, including an interchangeable lens.

6. The system of claim 5, wherein the optical member includes at least one of the following:
a cylindrical lens;
a concave lens;
a convex lens; and
a projection specific optical member.

7. The system of claim 4, wherein the member includes an impression of the projection.

8. The system of claim 4, wherein the member is movable in relation to the light source, the movement configured to vary the size of the projection.

9. The system of claim 4, wherein an assembly formed by the light source and the member is configured to move angularly in relation to the vehicle to vary the predetermined distance and position of the projection in relation to the vehicle.

10. The system of claim 1, wherein the vehicle is a powered material handling vehicle.

11. A vehicle proximity warning system comprising:
at least one laser mounted on a vehicle, the laser configured to emit a laser beam, forming a projection, wherein the projection is projected peripherally substantially all around the vehicle onto a vehicular travelling surface, up to a predetermined distance from the vehicle, establishing a vehicular unsafe zone, the projection comprising:
at least one of an image, a visually perceivable message, and a demarcation curve; and
at least one optical member, including an interchangeable lens, configured to be positioned in front of the laser, the laser beam configured to pass across the optical member, forming the projection.

12. The system of claim 11, wherein the optical member includes at least one of the following:
a cylindrical lens;
a concave lens;
a convex lens; and
a projection specific optical member.

13. The system of claim 11, wherein the vehicle is a powered material handling vehicle.

14. The system of claim 11, wherein the optical member includes an impression of the projection, and is movable relative to the laser, the movement configured to vary the size of the projection.

15. The system of claim 11, wherein an assembly formed by the laser and the optical member is configured to move angularly in relation to the vehicle to vary the predetermined distance and position of the projection in relation to the vehicle.

16. A method of safely operating a vehicle, the method comprising:
projecting a laser beam via at least one laser, forming a projection, wherein the laser is mounted on the vehicle and the projection is projected peripherally substantially all around the vehicle onto a vehicular travelling surface, up to a predetermined distance from the vehicle, establishing a vehicular unsafe zone.

17. The method of claim 16, wherein the projection comprises at least one of the following:
an image;
a visually perceivable message; and
a demarcation curve.

18. The method of claim 16 further comprising passing the laser beam across an optical member that includes an interchangeable lens, to form the projection, the optical member including an impression of the projection, wherein the optical member is movable relative to the laser, the movement configured to vary the size of the projection.

19. The method of claim 18, wherein the optical member includes at least one of the following:
a cylindrical lens;
a concave lens;
a convex lens; and
a projection specific optical member.

20. The method of claim 18, wherein an assembly of the laser and the optical member is configured to move angularly in relation to the vehicle to vary the predetermined distance and position of the projection in relation to the vehicle.
